(19) United States
(12) Patent Application Publication
(10) Pub. No.: US 2025/0026438 A1
(43) Pub. Date: Jan. 23, 2025

(54) Method for the Maintenance of an Electric Bike

(71) Applicant: Robert Bosch GmbH, Stuttgart (DE)

(72) Inventors: Matthias Weinmann, Balingen (DE); Daniel Baumgaertner, Neustetten (DE)

(21) Appl. No.: 18/710,324

(22) PCT Filed: Nov. 7, 2022
(86) PCT No.: PCT/EP2022/080924

§ 371 Date: May 15, 2024

(30) Foreign Application Priority Data
Nov. 19, 2021 (DE) 10 2021 213 020.8

(51) Int. Cl. B62M 6/45; B62J 27/00; B62J 45/412

(52) U.S. Cl. CPC B62M 6/45; B62J 27/00; B62J 45/412

(57) ABSTRACT

A method for the maintenance of an electric bike includes (i) activating a maintenance mode of a drive unit of the electric bike in response to an activation signal, wherein the electric bike, during the maintenance mode, is in a stationary state relative to surroundings, and (ii) operating the drive unit in the maintenance mode in response to a one-time user input by way of the input unit.

### PRIOR ART

The present invention relates to a method for the maintenance of an electric bike.

Electric bikes are known which have electric motors that are intended to support the manual pedaling force of a rider by means of a torque generated by the electric motor. To maintain such electric bikes, for example to oil a bike chain or to adjust the gearshift, the corresponding components of the electric bike are often operated manually by an operator.

### DISCLOSURE OF THE INVENTION

In contrast, the method according to the invention having the features of claim 1 is characterized by the fact that particularly simple and time-efficient maintenance of an electric bike can be carried out. In particular, motor support can be actively used to facilitate maintenance steps. According to the invention, this is achieved by a method for maintaining an electric bike, which comprises the steps of: activating a maintenance mode of a drive unit of the electric bike in response to an activation signal, and operating the drive unit in the maintenance mode in response to a one-time user input by means of an input unit. During maintenance mode, the electric bike stands still relative to its surroundings.

In particular, the drive unit is designed as an electric motor and is preferably set up to support a manual pedaling force of a rider of the electric bike by a motor torque during a riding operation of the electric bike. In particular, the drive unit is set up to generate the motor torque when the electric bike is being ridden only when the rider applies manual pedaling force. Preferably, propulsion of the electric bike by the drive unit alone is prevented.

In the method, the maintenance mode is provided, in particular in addition to a driving mode of the drive unit, in which maintenance of the electric bike can be carried out more easily. The maintenance mode of the drive unit can only be active when the electric bike is stationary.

Preferably, the stationary state of the electric bike relative to the surroundings can be actively detected, for example by means of a sensor system of the electric bike. Preferably, the maintenance mode can only be activated by the activation signal in response to a detected stationary state of the electric bike. Alternatively, the drive unit can preferably only be operated in maintenance mode in such a way that the electric bike cannot be moved forward, for example by means of a low output torque.

Thus, by operating the drive unit in maintenance mode, a motor torque that can be generated by the drive unit can be actively used, in particular to facilitate maintenance work. For example, the drive unit can be used to actively move parts of the electric bike's drive train in order to simplify maintenance work.

The fact that the drive unit is operated in response to a one-time user input by means of the input unit also makes it particularly easy for a user to initiate motor-assisted maintenance. A one-time user input is considered to be a brief operation, for example similar to pressing a button. This means that no permanent actuation is required, for example by permanently holding a button or similar.

The input unit can be designed in a variety of ways. For example, the input unit can be integrated into an on-board computer of the electric bike. Alternatively, the input unit can comprise a switch on the electric bike. Alternatively, the input unit can comprise a user device of the user, wherein the activation signal is transmitted to the electric bike, for example in response to an actuation by means of an application of the user device and by means of radio transmission.

The dependent claims relate to preferred further embodiments of the invention.

Preferably, the drive unit is operated in the maintenance mode in a first operating mode in such a way that a bike chain of the electric bike is moved. In particular, an output torque is generated by the drive unit, which moves the bike chain, especially via a chainring connected to the drive unit. This makes it particularly easy and convenient to maintain the bike chain and/or gearshift of the electric bike. For example, an operator can oil the bike chain particularly conveniently.

It is particularly preferable to stop operating the drive unit when the bike chain has traveled a predefined chain path. Chain path is defined as the distance traveled by a predefined point on the bike chain, for example a chain link, while the chain is moving. Preferably, operation of the drive unit is stopped when the bike chain has traveled a chain path that corresponds to the total length of the bike chain. This means that the operation of the chain preferably causes exactly one complete rotation of the bike chain. This makes it particularly easy and convenient to maintain the bike chain, for example for cleaning and/or oiling. Preferably, the chain path is related to the rotation of an output shaft of the drive unit via a transmission between the drive unit and the bike chain, for example via a chainring. For example, the output shaft can be rotated by a predefined number of revolutions in order to move the bike chain by the predefined chain path.

Preferably, the method generates an output signal, in particular an acoustic and/or optical and/or haptic signal, when the bike chain has passed through a predefined chain path. Preferably, the output signal is generated when the bike chain has traveled a chain path that corresponds to the total length of the bike chain. This means that the operator can easily detect which part of the bike chain has been moved past a certain point, for example, after exactly one complete cycle of the bike chain using the output signal.

Preferably, the drive unit is operated with a predetermined maintenance torque, which is a maximum of 20%, in particular a maximum of 10%, preferably a maximum of 5%, of a maximum torque of the drive unit. In particular, the maintenance torque is a maximum of 5 Nm, preferably a maximum of 2 Nm. This is a simple way of passively preventing hazards for the operator and/or unintentional forward movement of the electric bike during maintenance mode.

Preferably, the drive unit is operated at a predetermined maintenance speed, which is a maximum of 20%, in particular a maximum of 10%, preferably a maximum of 5%, of a maximum speed of the drive unit. Similar to the previous paragraph, this is a simple way of passively preventing danger and/or unintentional forward movement of the electric bike.

Further preferably, the method further comprises the steps of:
detecting a blockage in a drive train of the electric bike, and
stopping the operation of the drive unit in response to a detected blockage in the drive train.

For example, the blockage can be detected based on a change in torque and/or a change in speed of the drive unit. Stopping can prevent damage to the electric bike in particular, as well as, for example, putting the operator at risk. In particular, all components of the electric bike that enable torque generation and torque transmission in order to drive a rear wheel of the electric bike are regarded as the drive train.

A rear wheel of the electric bike is rotated particularly preferably by moving the bike chain. The method further comprises one or more of the following steps:
automatic diagnosis of a speed sensor of the electric bike during rotation of the rear wheel, wherein the speed sensor is arranged to detect a speed of the rear wheel,
automatic diagnosis of an anti-lock braking system of the electric bike by actuating the anti-lock braking system while the rear wheel is rotating, in particular wherein the actuation of the anti-lock braking system takes place by actuating a rear wheel brake,
automatic diagnosis of an electric bike gearshift by activating the gearshift while the rear wheel is rotating,
automatic adjustment of the electric bike's gearshift by operating the gearshift while the rear wheel is rotating.
   The automatic diagnosis is in particular a function check carried out automatically by the electric bike, for example by a control unit of the electric bike. For example, sensor data can be captured and compared with calibration sensor data, which reflects a functional state. In the event of a deviation, for example, a defect can be detected.

Further preferably, the drive unit comprises a rotor and a stator, wherein the drive unit is operated in the maintenance mode in a second operating mode so as to rotate the rotor without generating an output torque by the drive unit. For example, a freewheel can be activated between the rotor and the output shaft and/or chainring. This means that other operating functions of the drive unit can also be easily checked and/or adjusted.

Particularly preferably, the drive unit is operated in the maintenance mode in a third operating mode by actuating the drive unit with a predetermined diagnostic current without an output torque being generated by the drive unit. For example, the drive unit can be supplied with a diagnostic current in such a way that the rotor does not rotate. In particular, this can be used to automatically check a power supply to the drive unit.

Preferably, the method further comprises the steps of:
detecting a current consumption of the drive unit during operation of the drive unit, in particular in the second or third operating mode, and
detection of a defect in the drive unit based on the detected current consumption.
   For example, a defect can be detected by comparing the detected current consumption with a target current consumption. This makes automatic diagnosis of the drive unit particularly easy and convenient for the operator.

Preferably, the activation signal can be generated by means of a user input via the input unit. For example, the operator can activate the maintenance mode by pressing a button or similar. Alternatively or additionally preferably, the activation signal is generated, in particular automatically, in response to a sensor-based detection of a maintenance situation. For example, the maintenance situation can be detected in response to predefined accelerations and/or orientations of the electric bike. Alternatively or additionally preferably, the activation signal is generated in response to a connection between the electric bike, in particular a control unit and/or the drive unit of the electric bike, and a maintenance device. The maintenance device can preferably be a computer, by means of which, for example, sensor data of the electric bike can be read out and/or by means of which the electric bike can be configured, for example.

Preferably, the maintenance situation is detected in response to a sensor-based overhead detection of the electric bike, for example based on acceleration sensors and/or position sensors of the electric bike. This means that if it is detected that the electric bike is being placed in an overhead orientation, maintenance mode is automatically activated.

Preferably, the method further comprises the steps of:
detecting the forward movement of the electric bike relative to its surroundings, and
preventing operation of the drive unit if forward movement of the electric bike is detected while maintenance mode is active. In particular, this is a simple way of preventing the drive torque of the drive unit from being used undesirably to move the bike forward. For example, this can also prevent damage or hazards.

Another preferred method of detecting the forward movement of the electric bike is based on the rotational speed of a non-driven wheel, for example a front wheel, of the electric bike and/or based on location data and/or based on movement data from a sensor system of the electric bike.

### BRIEF DESCRIPTION OF THE DRAWINGS

The invention is described below based on exemplary embodiments in connection with the FIGURE. In the FIGURE, functionally identical components are respectively denoted by identical reference signs. Shown are:

FIG. 1 a simplified schematic view of a method for maintaining an electric bike according to a preferred exemplary embodiment of the invention.

### PREFERRED EMBODIMENT OF THE INVENTION

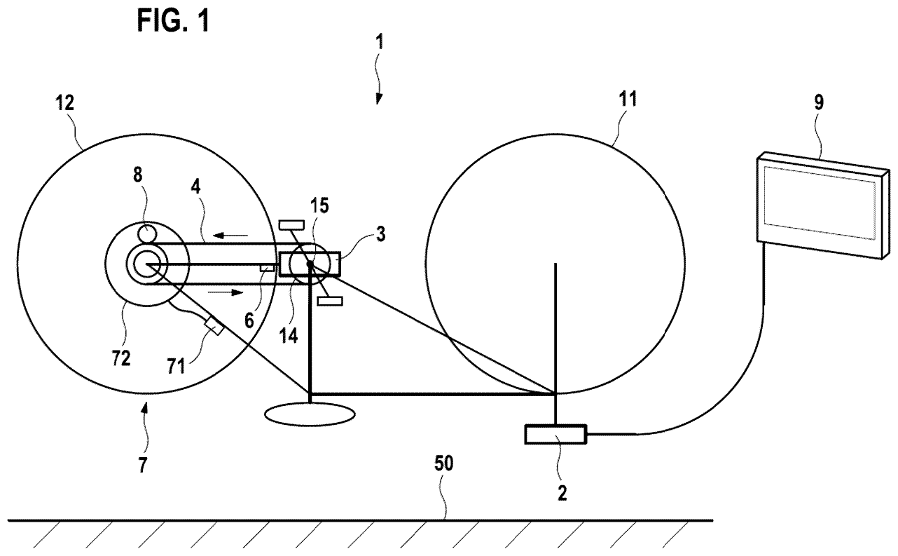

FIG. 1 shows a highly simplified schematic view of a method for maintaining an electric bike 1 according to a preferred exemplary embodiment of the invention.

The electric bike 1 comprises a drive unit 3, which is arranged in the region of a bottom bracket 15. The drive unit 3 is an electric motor which is set up to provide motorized support for the manual pedaling force of a rider of the electric bike 1 by means of a drive torque. When the electric bike 1 is in riding mode, the drive torque of the drive unit 3 is only provided when the rider is pedaling at the same time, which can be captured using a pedal sensor, for example.

The electric bike 1 also comprises a chainring 14, which can be driven by the drive unit 3, a bike chain 4 and a gearshift 8. A rear wheel 12 of the electric bike 1 is driven via the bike chain 4 and the gearshift 8.

Furthermore, the electric bike 1 comprises an anti-lock braking system 7, which has an anti-lock braking unit 71 and a rear wheel brake caliper 72. For example, the anti-lock braking system 7 is part of a hydraulic braking system of the electric bike 1. The anti-lock braking unit 71 is set up to modulate a fluid pressure at the rear wheel brake caliper 72 in an anti-lock braking mode in order to prevent the rear wheel 12 from locking during braking.

In order to enable simple and convenient maintenance of the electric bike 1, the method according to the invention is provided.

In the method, a maintenance mode of the drive unit 3 is first activated in response to an activation signal.

The activation signal can be generated in various ways. For example, the activation signal can be generated when, as shown in FIG. 1, an input unit 2, which can be an on-board computer, for example, is connected to a maintenance device 9. The maintenance device 9 can, for example, comprise diagnostic software for diagnosing the electric bike 1 or components thereof.

Furthermore, the activation signal can be generated automatically when a maintenance situation is detected by sensors on the electric bike 1. For example, a position sensor can capture when the electric bike 1 is brought into an overhead position as shown in FIG. 1 and generate the activation signal in response to it. The overhead position is characterized in that the electric bike 1 is oriented inversely with respect to surroundings 50 and a gravitational direction of an earth gravity field compared to a riding position.

The activation signal can also be generated by a user input. For example, the user input can be made via the input unit 2.

As an alternative to the configuration shown in FIG. 1, in which the input unit 2 is attached to the electric bike 1, the input unit 2 can also be part of a user device, such as a smartphone. A user device can transmit the activation signal to the electric bike 1 by means of radio transmission, for example.

When maintenance mode is activated, operation of the drive unit 3 can be initiated by the input unit 2 in response to a one-time user input. This means, for example, that after pressing a button once, the drive unit 3 is operated, preferably until the button is pressed again or until a condition for ending the operation of the drive unit 3 occurs.

The drive unit 3 can be operated in various operating modes. In a first operating mode, the drive unit 3 is operated in such a way that the bike chain 4 is moved.

The bike chain 4 can be moved in such a way that the rear wheel 12 is rotated. Various steps can be performed during the rotation of the rear wheel 12. In particular, automatic diagnostics, i.e. functional tests, of various components of the electric bike 1 can be carried out.

Preferably, an automatic diagnosis of a speed sensor 6 is carried out, which is set up to detect a speed of the rear wheel 12. For example, this can be done by simply checking the plausibility of a speed value. Alternatively or additionally, a predefined speed of the rear wheel 12 can be set by predefined actuation of the drive unit 3 and the gearshift 8, and the measured speed value of the speed sensor 6 can be compared with a target speed value.

The anti-lock braking system 7 can also be diagnosed. For example, a function of the anti-lock braking system 7 can be tested by actuating the rear wheel brake caliper 72 during the rotation of the rear wheel 12 and determining the resulting deceleration of the rotation of the rear wheel 12.

In addition, an automatic diagnosis of the gearshift 8 of the electric bike 1 can be carried out. Advantageously, the gearshift 8 is an electronic gearshift, which can be actuated in particular by a control unit of the electric bike 1. For example, a predetermined gear ratio can be set automatically to diagnose the gearshift 8, and a deviation from a speed to be expected with the predetermined gear ratio can be checked based on a captured speed of the rear wheel 12.

Automatic adjustment, i.e. setting, of the gearshift 8 can also be carried out. For example, the adjustment can be made by adjusting a shift mechanism controlled by a control unit of the electric bike 1 in order to optimize a shift function.

Furthermore, in the first operating mode, the drive unit 3 can be operated in such a way that operation is stopped when the bike chain 4 has traveled a predefined chain path. For example, operation of the drive unit 3 can stop when the bike chain 4 has completed exactly one revolution. This means that maintenance of the bike chain 4, such as cleaning or oiling, can be carried out particularly easily and conveniently for the operator.

Alternatively, instead of stopping the operation of the drive unit 3, an output signal can be generated when the bike chain 4 has traveled a predefined chain path, for example exactly one revolution. Such an output signal can, for example, be an acoustic and/or visual and/or haptic output signal.

Furthermore, the drive unit 3 can be operated in the maintenance mode in a second operating mode. In the second operating mode, the drive unit 3 is operated in such a way that a rotor of the drive unit 3 is rotated without an output torque being generated by the drive unit 3. This allows, for example, the correct functioning of the electric motor operation of the drive unit 3 to be checked.

In the second operating mode, a defect in the drive unit 3 can also be detected by detected a current consumption of the drive unit during operation based on this detected current consumption.

Furthermore, the drive unit 3 can be operated in a third operating mode within the maintenance mode. In the third operating mode, the drive unit 3 is actuated with a predetermined diagnostic current without the drive unit 3 generating an output torque and, in particular, without the rotor being set in rotation. In the third operating mode, a defect in the drive unit 3 can also be detected by detecting the current consumption.

While the maintenance mode of the drive unit 3 is active, a maximum output torque of the drive unit 3 is limited to a predetermined maintenance torque. The maintenance torque is limited to a maximum of 20% of the maximum torque of the drive unit 3 in normal driving operation. This can prevent unintentional forward movement of the electric bike 1 and can also reduce the likelihood of danger to the operator from the operation of the drive unit 3 as far as possible.

Similarly, a maximum speed of the drive unit 3 during maintenance mode is limited to a maintenance speed that is a maximum of 20% of a maximum speed of the drive unit 3 in normal driving mode.

Maintenance mode can be deactivated in various ways. For example, this can be initiated by a deactivation signal, which, like the activation signal, can preferably be generated by means of a user input.

Alternatively, deactivation of maintenance mode or even prevention of maintenance mode can be automatically prevented from the outset in certain situations. For example, if it is detected that the electric bike 1 is moving relative to surroundings 50, such automatic deactivation or prevention can take place. The electric bike 1 can be moved forward in this way, for example, by means of a rotational speed of a non-driven front wheel 11 of the electric bike 1. Alternatively or additionally, a forward movement can be detected based on location data and/or movement data from a sensor system of the electric bike 1.

1. A method for the maintenance of an electric bike, comprising:
activating a maintenance mode of a drive unit of the electric bike in response to an activation signal,
wherein the electric bike, during the maintenance mode, is in a stationary state relative to surroundings, and
operating the drive unit in the maintenance mode in response to a one-time user input by way of the input unit.

2. The method according to claim 1, wherein the drive unit is operated in a first operating mode to move a bike chain of the electric bike.

3. The method according to claim 2, wherein the operation of the drive unit is stopped when the bike chain has traveled a predefined chain path.

4. The method according to claim 2, further comprising:
generating an output signal when the bike chain has traveled a predefined chain path.

5. The method according to claim 2, wherein the drive unit is operated with a predetermined maintenance torque which is at most 20% of a maximum torque of the drive unit.

6. The method according to claim 2, wherein the drive unit is operated at a predetermined maintenance speed, which is at most 20% of a maximum speed of the drive unit.

7. The method according to claim 2, further comprising:
detecting a blockage in a drive train of the electric bike, and
stopping the operation of the drive unit in response to a detected blockage in the drive train.

8. The method according to claim 2, wherein moving the bike chain rotates a rear wheel of the electric bike, and wherein the method further comprises one or more of the following:
automatically diagnosing a speed sensor of the electric bike during rotation of the rear wheel, wherein the speed sensor is arranged to detect a rotational speed of the rear wheel,
automatically diagnosing an anti-lock braking system of the electric bike by actuating the anti-lock braking system while the rear wheel is rotating,
automatically diagnosing a gearshift of the electric bike by actuating the gearshift while the drive unit is being driven, and
automatically adjusting the gearshift of the electric bike by actuating the gearshift while the drive unit is being driven.

9. The method according to claim 1, wherein the drive unit comprises a rotor and a stator, and wherein operating the drive unit in a second operating mode is such as to rotate the rotor without generating an output torque by the drive unit.

10. The method according to claim 1, wherein the drive unit is operated in a third operating mode by actuating the drive unit with a predetermined diagnostic current without generating an output torque by the drive unit.

11. The method according to claim 2, further comprising:
detecting a current consumption of the drive unit during operation of the drive unit, and
detecting a defect in the drive unit based on the detected current consumption.

12. The method according to claim 1, wherein:
the activation signal is configured to be generated by way of a user input by way of the input unit, and/or
the activation signal is generated in response to a sensor-based detection of a maintenance situation, and/or
the activation signal is generated in response to a connection of the electric bike to a maintenance device.

13. The method according to claim 12, wherein the maintenance situation is detected in response to a sensor-based overhead detection of the electric bike.

14. The method according to claim 1, further comprising:
detecting a forward movement of the electric bike relative to surroundings, and
preventing operation of the drive unit if forward movement of the electric bike is detected while the maintenance mode is active.

15. The method according to claim 14, wherein the detection of the forward movement of the electric bike is based on detection of a rotational speed of a non-driven wheel of the electric bike and/or based on location and/or movement data of a sensor system of the electric bike.

16. The method according to claim 4, wherein the output signal is an acoustic and/or optical and/or haptic signal.

17. The method according to claim 2, wherein the drive unit is operated with a predetermined maintenance torque which is at most 10% of a maximum torque of the drive unit.

18. The method according to claim 2, wherein the drive unit is operated with a predetermined maintenance torque which is at most 5%, of a maximum torque of the drive unit.

19. The method according to claim 2, wherein the drive unit is operated at a predetermined maintenance speed, which is at most 10% of a maximum speed of the drive unit.

20. The method according to claim 2, wherein the drive unit is operated at a predetermined maintenance speed, which is at most 5% of a maximum speed of the drive unit.
